(19) United States
(12) Patent Application Publication
(10) Pub. No.: US 2018/0278792 A1
(43) Pub. Date: Sep. 27, 2018

(54) SYSTEM AND METHOD FOR STORING SCANNED DOCUMENTS

(71) Applicants: Kabushiki Kaisha Toshiba, Minato-ku (JP); Toshiba TEC Kabushiki Kaisha, Shinagawa-ku (JP)

(72) Inventor: Louis ORMOND, Irvine, CA (US)

(21) Appl. No.: 15/466,373

(22) Filed: Mar. 22, 2017

(51) Int. Cl. H04N 1/21; H04N 1/00; H04N 1/32

(52) U.S. Cl. CPC H04N 1/2175; H04N 1/00411; H04N 1/32128; H04N 2201/3229; H04N 2201/0081; H04N 2201/218; H04N 2201/0094

(57) ABSTRACT

A system and method for simplified scanning of tangible documents commences with scanning them into electronic documents on an MFP. The MFP controller generates a scan command indicia and commences a scan when it is selected by a user. A processor in the controller generates an electronic document file from the scan operation associatively with a scan folder file and generates scan folder file indicia on a display and electronic document indicia corresponding to each electronic document file in the scan folder. A user selects a document and specifies instructions for processing the document which is completed by the processor.

### TECHNICAL FIELD

This application relates generally to multifunction peripherals. The application relates more particularly the storing and retrieval of scanned documents on a multifunction peripheral.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

MFPs are typically provided with a fixed set of functions that are available to device end users. These typically include scanning, copying, printing or e-mailing documents. When an MFP is used as a scanner, a typical MFP will solicit a destination for the resultant electronic scan file. For example, if a scan is selected, the MFP may prompt for input of an e-mail address. Once scanned, the resulting electronic document will be e-mailed as an attachment to the specified e-mail address.

### SUMMARY

In accordance with an example embodiment tangible documents are scanned into electronic documents on an MFP. The MFP controller generates a scan command indicia and commences a scan when it is selected by a user. A processor in the controller an electronic document file from the scan operation associatively with a scan folder file and generates scan folder file indicia on a display and electronic document indicia corresponding to each electronic document file in the scan folder. A user selects a document and specifies instructions for processing it which is completed by the processor.

### BRIEF DESCRIPTION OF THE DRAWINGS

Various embodiments will become better understood with regard to the following description, appended claims and accompanying drawings wherein:

FIG. 1 is an example embodiment of a scanning system;

FIG. 2 is an example embodiment of a multifunction peripheral;

FIG. 3 is an example embodiment of a touchscreen user interface;

FIG. 4 is an example embodiment of a scanner system;

FIG. 5 is a block diagram of example software modules;

FIG. 6 is an example embodiment of a one-touch MFP scanning operation; and

FIG. 7 is a flowchart of an example embodiment of one touch scanning.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Scan functions on an MFP are typically associated with a method to move the scanned images from the MFP to another location. While this is useful, this fixed workflow fails to allow a user to easily re-use the scanned images. For example, a scan to e-mail will send the scanned files to the designated e-mail addresses, then erase the images from the MFP. If a user needs to send the document to another e-mail address, send it to another location, or make updates, re-scanning the originals is necessary.

There are situations when a user may wish to scan a document, but actions other than e-mailing are desirable. For example, the user may wish to send the electronic document to a network location, save it locally on the MFP, or save it to a portable data device, such as a flash drive, CD or DVD. A user may wish to send the electronic document to their networked computer, or to a portable device such as a tablet computer, notebook computer or smartphone, such as via a tethered connection, or wirelessly such as via BLUETOOTH, near field communication (NFC) or optical data transfer. A user interface is suitably created to allow a user to accomplish such options instead of just providing an e-mail option. But this too can be problematic, such as in situations involving multiple operations to be performed. This can be particularly problematic when multiple documents are scanned by a user, especially if different operations are desired for different documents in the scan set.

In accordance with the subject application, example embodiments include a capability for a network capable electromechanical device, such as an MFP, to store scanned files in a container that is easily accessible with fewer keystrokes, referred to herein as “one touch,” from the front panel of the device, while it will be understood that any suitable input or combination of inputs to accomplish device interaction are included with this designation. Once files are scanned into the device, with one touch, a user of the system can access the images to preview, edit, add or delete images, forward the images to various network destinations, or any number of other operations, or combinations of operations, associated with a scanning process.

Further example embodiments herein include an MFP with a capabilities to: scan and store image files to a container on the host machine that is easily accessible by a user from the front panel of the device; create a new container for each scan job, or chose to add to an existing container; delete the container and its contents at the end of a user session; or interface with other functions of the device in order to allow files within the container to be printed, faxed, or otherwise sent to multiple network locations.

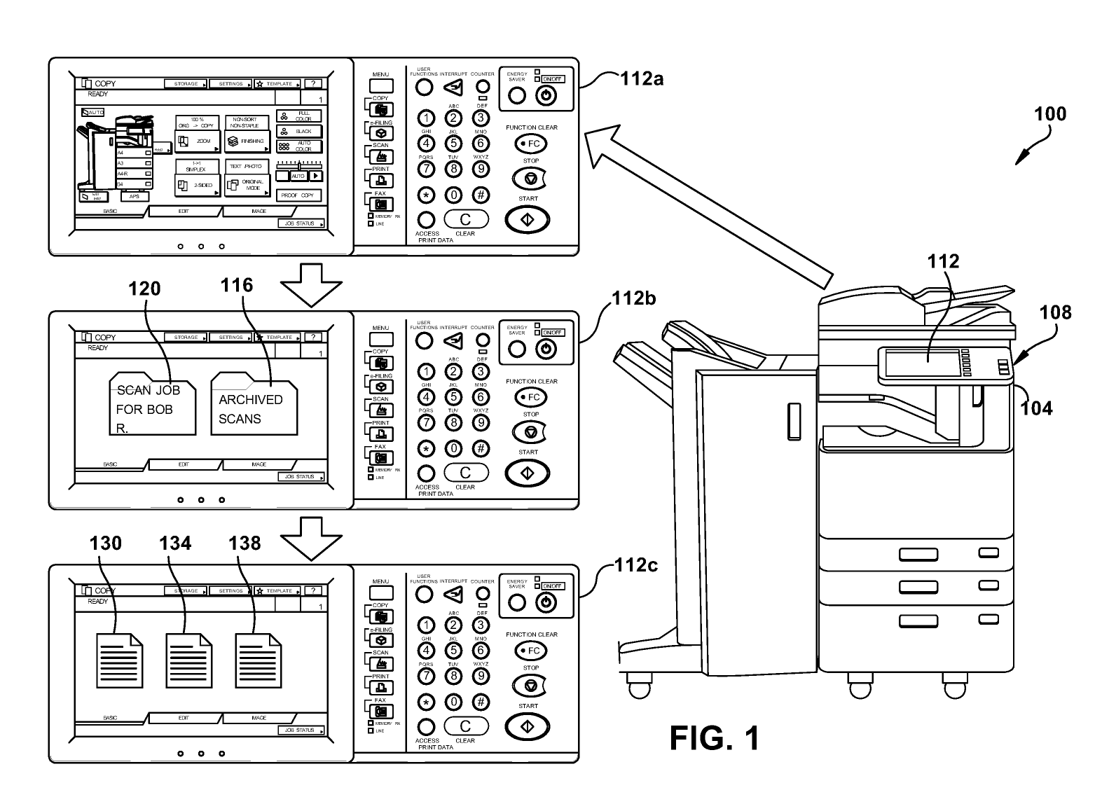

Referring to FIG. 1, illustrated is an example embodiment of a scanning system 100 that includes MFP 104. MFP 104 includes a user interface 108, suitably including touch screen display 112. In the illustrated example, touchscreen 112 is configurable to provide interface rendering 112a for scan selection. Once a scan selection is made, electronic document files from scanned documents are automatically stored in a scan capture file as illustrated on interface rendering 112b. A generic scan folder 116 is suitably a default location for scan files. Alternatively, a user specific scan folder 120 may be used if a user is logged into the MFP or if the user is otherwise identifiable. A user may select a scan file folder, such as by touching the corresponding icon on the touchscreen, resulting in a display of scanned electronic documents, such as icons 130, 134 and 138. One or more of these icons can be selected for additional functions, such as sending to multiple locations, deleting, converting format, editing, or the like as will be detailed further below.

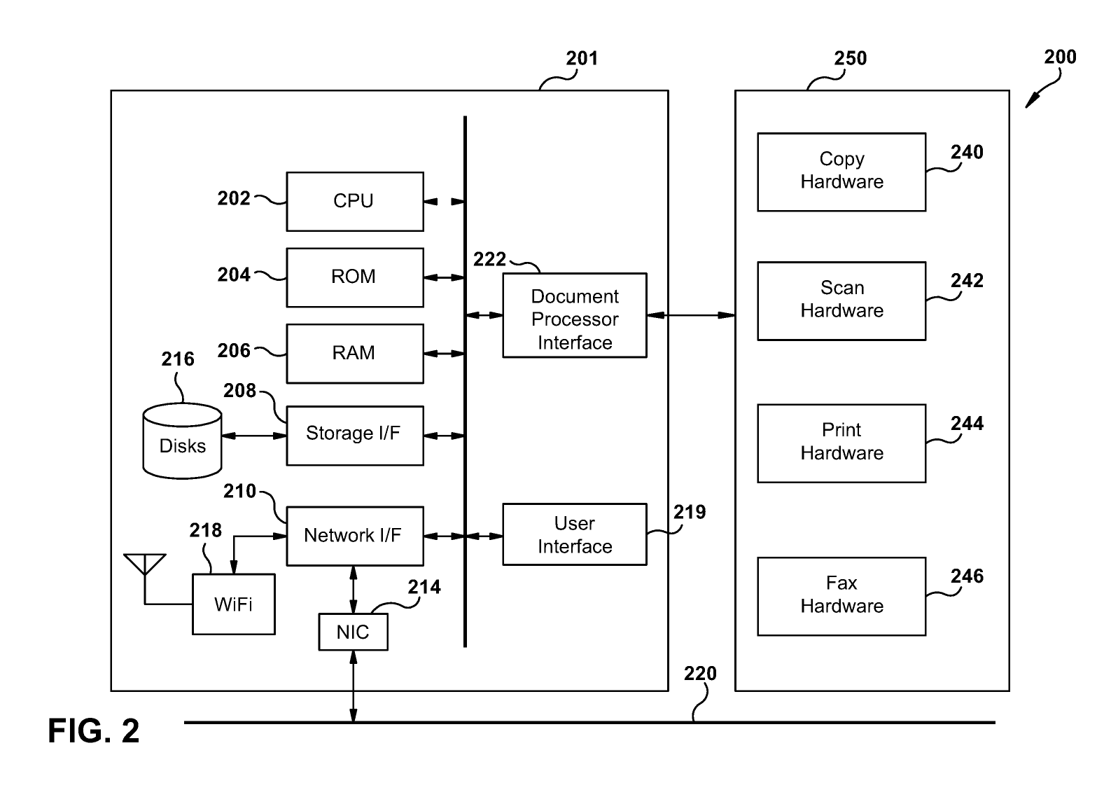

Turning now to FIG. 2, illustrated are functional device components 200 suitably comprising a multifunctional peripheral such as MFP 104 of FIG. 1. Included is controller 201 comprised of one or more processors, such as that illustrated by processor 202. Each processor is suitably associated with non-volatile memory such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like.

Processor 202 can also be in data communication with any suitable user input/output (I/O) interface 219 which provides data communication with user peripherals, such as displays, keyboards, mice, track balls, touch screens, or the like. Hardware monitor suitably provides device event data, working in concert with suitably monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

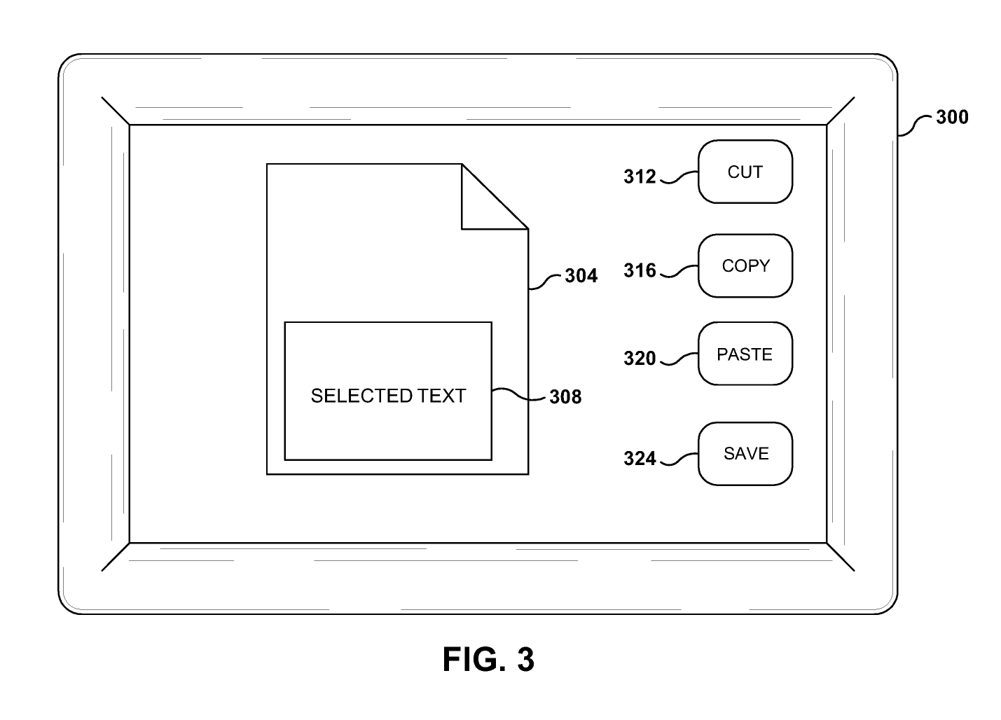

Referring next to FIG. 3, illustrated is an example embodiment of a touchscreen user interface rendering 300, suitably resultant by selecting a document thumbnail icon, such as icon 130, 134 or 138 of FIG. 1. An expanded view or blow up 304 is generated on the touchscreen. In the illustrated example, a user can edit the displayed document, such as by selecting a document area by touching a corner of a desired document area and dragging diagonally across the screen to define selected text area 308. A user may choose to cut, copy, paste, or save a selected area by depressing buttons 312, 316, 320 or 324, respectively. It is understood that any suitable function may be selected for a document in a similar matter, such as deleting, forwarding, e-mailing, editing, etc.

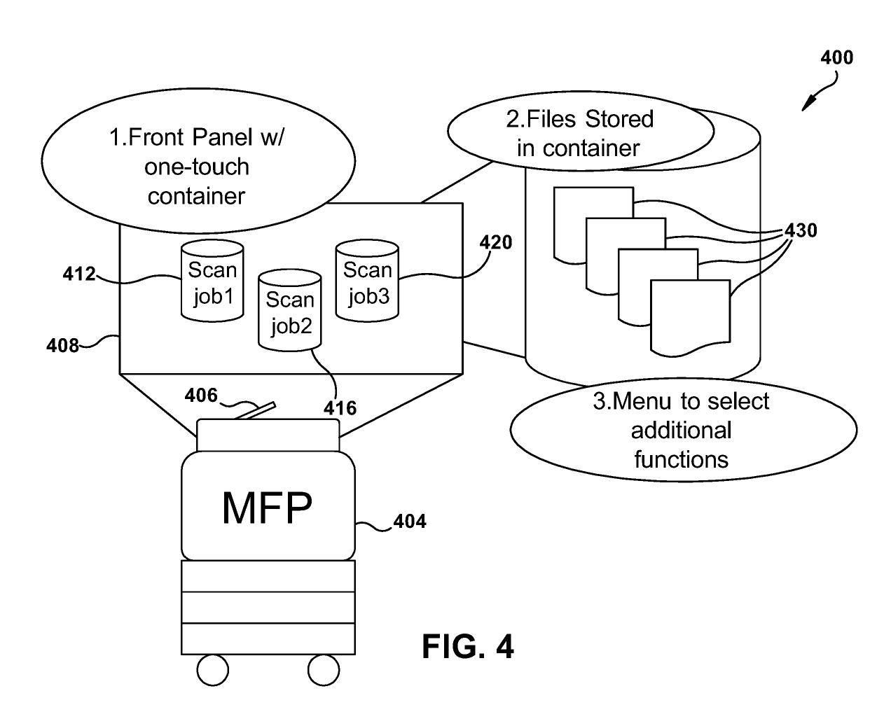

Referring next to FIG. 4, illustrated is an example embodiment of a one-touch scanner system 400 that includes MFP 404. In this example, a user has tangible documents that are input to sheet feeder 406 of MFP 404. Documents are scanned in three separate scanning operations. Once completed, MFP user interface 408 is generated. Documents from a first scan job are associated with icon 412, documents from a second scan job are associated with icon 416 and document from a third scan job are associated with icon 420. A user can select a desired icon, wherein documents associated with that icon are displayed via document icons 430, thumbnails, document titles, or the like.

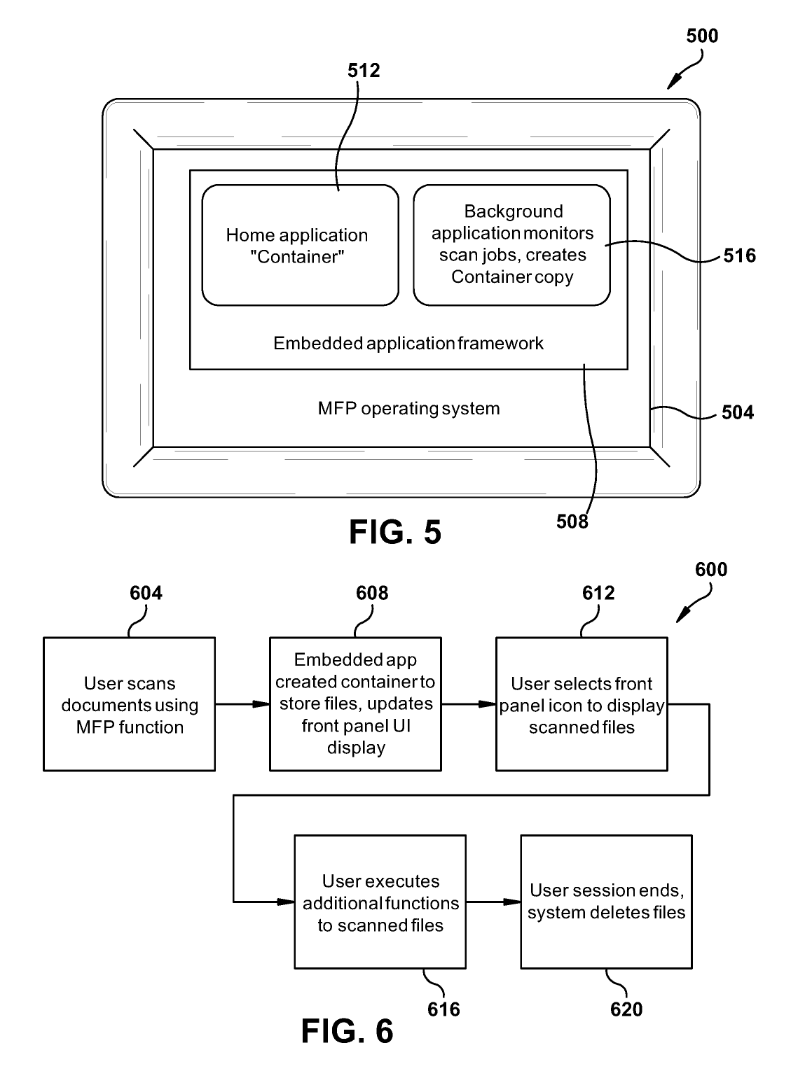

Referring now to FIG. 5, illustrated is a software module block diagram 500 of an example embodiment of a one touch scanning system as described herein. Included with MFP operating system 504 is embedded application framework 508 which includes a home application container module 512 and a background application module 516. Background application module 516 functions to monitor scan jobs and create containers for them.

FIG. 6 is a flowchart 600 of an example embodiment of a one-touch MFP scanning operation. A user commences operation by scanning documents on an MFP at block 604. Next, an embedded application creates a container for scanned document files and displays indicia for the container on a display at block 608. User selection of a container indicia, such as an associated icon, results in a display of indicia for container contents at block 612. Next, a user inputs selected functions for scanned files at block 616, and the selected operations are completed, ending the session and suitably deleting the files at block 620.

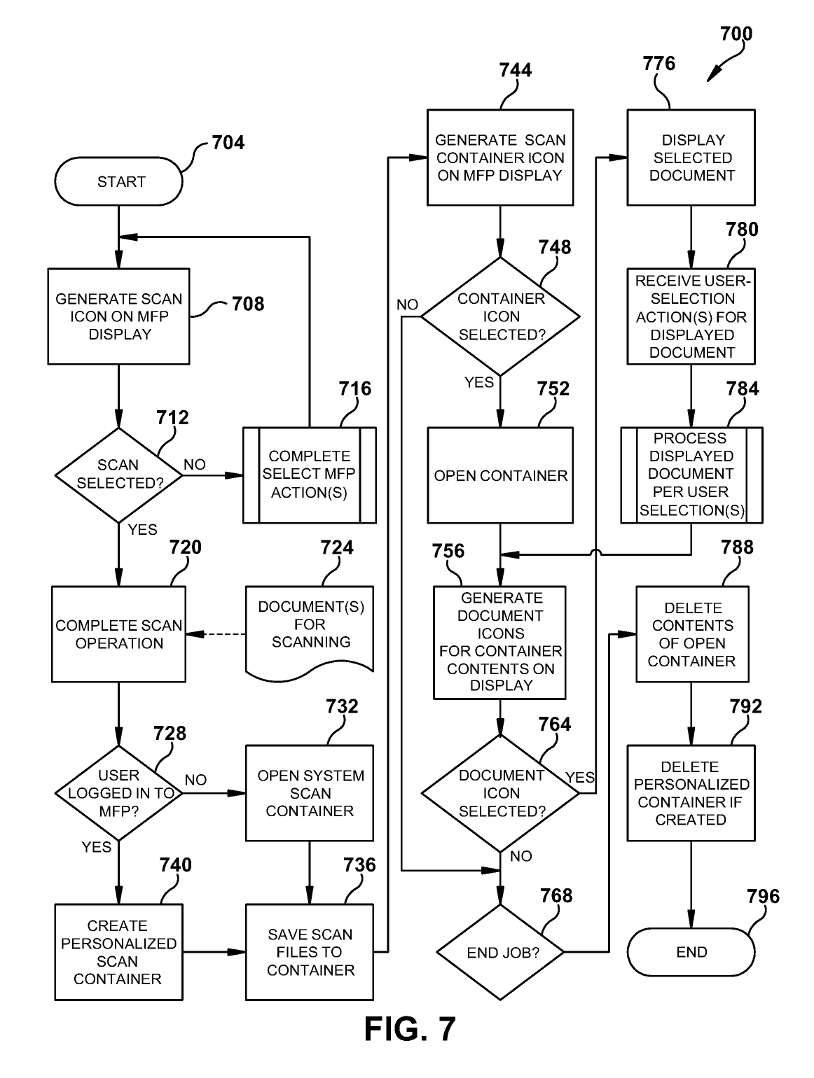

Referring next to FIG. 7, illustrated is a flowchart 700 of an example embodiment of one touch scanning via a suitably configured MFP. The process commences at block 704. Next, a scan icon, or any other suitable indicia to facilitate user selection of a scan operation, is generated at block 708. If no scan is selected at block 712, other device functions may be accessed and implemented at block 716 until a scan operation is selected. If a scan operation is selected at block 712, then scanning is completed at block 720 with one or more documents, in one or more document sets illustrated at block 724.

If it is determined at block 728 that a current user is not logged in, or otherwise identified or identifiable, then a default scan container, such as a file folder, is opened at block 732 and scan files are saved in that folder at block 736. Otherwise, a personalized scan container is suitably opened at block 740 and files are saved into that container at block 736. Next, indicia, such as a container icon, corresponding to the container containing the scan files is generated on the MFP display at block 744. If that container is not selected by the user at block 748, then process continues to block 768 as described below. If that container is selected by the user at block 748, such as by touching the icon on a touch screen display, content of that container is accessed at block 752 and indicia, such as document icons or thumbnails for the scan files are displayed at block 756. If a user selects a document by selection of its corresponding indicia at block 764, then that document is suitably rendered for display, in enlarged form in the case of thumbnails, at block 776. One or more user actions for the displayed document are selected at block 780 and these selections are implemented at block 784. The process then returns to block 756 until no other documents in the container require attention. When no document is selected at block 764, suitably from user input or passage of a set time period, the job is deemed ended at block 768, at which time container contents are deleted at block 788, any personalized container is deleted at block 792, and the process terminates at block 796.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A multifunction peripheral comprising:
a scan engine configured to scan tangible documents into electronic documents;
an intelligent controller including a processor and memory; and
a user interface including a display and a user input,
wherein the processor is configured for generating a scan command indicia corresponding to a scan command on the display,
wherein the processor is further configured to commence a scan operation by the scan engine in accordance with a user scan request corresponding a user selection corresponding to the scan command indicia received via the user input,
wherein the processor is further configured to save an electronic document file from the scan operation associatively with a scan folder file,
wherein the processor is further configured to generate a folder indicia on the display corresponding scan folder file,
wherein the processor is further configured to generate, on the display, electronic document indicia corresponding to each electronic document file saved with the scan folder,
wherein the processor is further configured to receive, via the user input, a user document selection corresponding to an electronic document associated with a displayed document indicia,
wherein the processor is further configured to receive document processing instructions corresponding to an electronic document file specified by the user document selection, and
wherein the processor is further configured to process the electronic document file specified by the document processing instructions on the specified electronic document file.

2. The multifunction peripheral of claim 1 wherein the processor is further configured to receive identification data corresponding to an identity of the user, and
wherein the processor is further configured to generate the scan folder file in accordance with received user identification data.

3. The multifunction peripheral of claim 2 wherein the processor is further configured to delete the electronic documents from the scan file folder upon completion of processing of the specified electronic document file, and
wherein the processor is further configured for deleting the generated scan folder file with deletion of the electronic documents.

4. The multifunction peripheral of claim 1 wherein the processor is further configured to delete the electronic documents from the scan file folder upon completion of processing of the specified electronic document file.

5. The multifunction peripheral of claim 4 wherein the processor is further configured to generate the electronic document indicia as a rendered image of the specified electronic document file.

6. The multifunction peripheral of claim 5 wherein the document processing instructions include an instruction for sending the specified electronic document to a destination, and
wherein the processor is further configured to receive destination data corresponding to a destination for sending of the specified electronic document, and
wherein the processor is further configured to send the specified electronic document to the destination.

7. The multifunction peripheral of claim 5 wherein the processor is further configured for editing the specified electronic document file in accordance with user commands received via the user input.

8. A method comprising:
scanning, on a multifunction peripheral, a plurality of tangible documents into a corresponding plurality of electronic documents in accordance with receipt of a user selected scan operation;
saving the electronic documents associatively with a scan folder file;
generating a folder indicia, on a display, corresponding to the scan folder file;
generating, on the display, electronic document indicia corresponding to each electronic document file saved with the scan folder;
receiving a user document selection corresponding to an electronic document associated with a displayed document indicia;
receiving document processing instructions corresponding to an electronic document file specified by the user document selection; and
processing the electronic document file specified by the document processing instructions on the specified electronic document file.

9. The method of claim 8 further comprising deleting the electronic documents from the scan file folder upon completion of processing of the specified electronic document file.

10. The method of claim 8 further comprising:
receiving identification data corresponding to an identity of the user; and
generating the scan folder file in accordance with received user identification data.

11. The method of claim 10 further comprising:
deleting the electronic documents from the scan file folder upon completion of processing of the specified electronic document file; and
deleting the generated scan folder file with deletion of the electronic documents.

12. The method of claim 10 further comprising generating the electronic document indicia as a rendered image of the specified electronic document file.

13. The method of claim 12 wherein the document processing instructions include an instruction for sending the specified electronic document to a destination and further comprising:
receiving destination data corresponding to a destination for sending of the specified electronic document; and
sending the specified electronic document to the destination.

14. The method of claim 12 further comprising editing the specified electronic document file in accordance with a received user command.

15. A multifunction peripheral comprising:
a scan engine configured to scan tangible documents into electronic documents;
an intelligent controller including a processor and memory; and
a touchscreen display,
wherein the processor is configured for generating a scan command icon corresponding to a scan command on the touchscreen display,
wherein the processor is further configured to commence a scan operation by the scan engine for each of a plurality of tangible documents in accordance with a user scan request corresponding to a user selection of the scan command icon,
wherein the processor is further configured to save an electronic document file corresponding to each of the plurality of tangible documents associatively with a scan folder file,
wherein the processor is further configured to generate a folder icon on the touchscreen display corresponding to scan folder file,
wherein the processor is further configured to generate, on the touchscreen display, a plurality of document icons wherein each document icon corresponds to an electronic document file saved with the scan folder,
wherein the processor is further configured to receive a user selection of a document icon on the touchscreen display,
wherein the processor is further configured to receive document processing instructions for an electronic document file specified by a selected document icon, and
wherein the processor is further configured to process a specified electronic document specified in accordance with the document processing instruction.

16. The multifunction peripheral of claim 15 wherein the processor is further configured to generate a thumbnail image of the specified electronic document on the touchscreen display.

17. The multifunction peripheral of claim 16 wherein the processor is further configured to receive destination data for the specified electronic document via the touchscreen display, and
wherein the processor is further configured to send the specified electronic document to a destination specified by the destination data.

18. The multifunction peripheral of claim 15 wherein the processor is further configured to generate an enlarged rendering of the specified electronic document in accordance with user selection of the thumbnail image on the touchscreen display.

19. The multifunction peripheral of claim 18 wherein the processor is further configured to receive an edit command via the touchscreen display, and
wherein the processor is further configured to edit the specified electronic document in accordance with a received edit command.

20. The multifunction peripheral of claim 19 wherein the processor is configured to print a rendering of an specified electronic document via a print engine.
